(19) United States
(12) Patent Application Publication
(10) Pub. No.: US 2015/0094090 A1
(43) Pub. Date: Apr. 2, 2015

(54) CACHING OF LOCATIONS ON A DEVICE

(71) Applicant: Samsung Electronics Co., Ltd., Suwon-si (KR)

(72) Inventors: Thomas PHAN, San Jose, CA (US); Albert BAEK, Fremont, CA (US); Zheng GUO, San Jose, CA (US); Abhishek SINGH, Sunnyvale, CA (US)

(21) Appl. No.: 14/498,805

(22) Filed: Sep. 26, 2014

Related U.S. Application Data
(60) Provisional application No. 61/884,893, filed on Sep. 30, 2013.

(51) Int. Cl. H04W 4/02; H04L 29/08; G06F 17/30

(52) U.S. Cl. CPC H04W 4/028; G06F 17/3087; H04L 67/2842
USPC 455/456.1

(57) ABSTRACT

Various devices, systems and methods for obtaining a location from a cache on a device are described. In various embodiments, the obtained location is based on data generated at the mobile device. Additional embodiments relate to cache hit determination techniques and techniques for sharing, managing and prepropagating the cache.

### FIELD OF THE INVENTION

This application claims priority of U.S. Provisional Patent Application No. 61/884,893, entitled “Caching Reverse-Geocoded Locations on Smartphones,” filed Sep. 30, 2013, which is incorporated herein by reference in its entirety for all purposes.

### BACKGROUND

Modern smartphones offer a wide variety of features. One useful feature is the ability to detect the smartphone's location. More specifically, the smartphone is able to determine whether the device is at a known landmark or at a particular city or address.

Such techniques may be used in a wide variety of applications. For example, some applications allow a mobile device to be used as a digital log or diary. When a user is entering a new entry into his or her log, the smartphone can automatically determine the city that he or she is in and attach it to the log entry. As a result, the user can later review the log entries and quickly recall all the places in which they were recorded.

A known process for obtaining the location of a smartphone may be described as follows. Initially, the smartphone identifies a geocoordinate that is associated with the current location of the device. A well known example of a geocoordinate is a pair of latitude-longitude coordinates. Typically, such coordinates are based on data obtained from Global Postioning System (GPS) satellites. The mobile device then transmits the coordinates to a suitable server. The server analyzes the coordinates and determines a location (e.g., a city name, an address, a state, etc.) that they are associated with. This determination process is commonly referred to as “reverse geocoding.” The server transmits the location data back to the mobile device. The mobile device then makes use of the location data e.g., a mobile application may then inform a user that he or she has entered the city identified by the reverse geocoding server. In various implementations, whenever a current location is required by an application, this process must be repeated. In applications that require frequent updates on the location of the device, such as many life logging and tourism applications, the repeated server requests can consume considerable amounts of battery power and bandwidth.

### SUMMARY

The present invention relates to various types of electronic devices. More specifically, the present invention involves a cache on a device that is used to store location information. In various embodiments, the device is a mobile device, including but not limited to a smartphone, smart glasses, a smart watch, a tablet or another type of computing device.

In one aspect, a method for obtaining a location from the cache will be described. In various embodiments, the obtained location is based on data that was generated at the device. The data generated at the device may vary widely, depending on the needs of a particular application. In some embodiments, for example, the device generates proximity domains or structures that help determine whether a cache hit has taken place. Any suitable algorithm, scheme, structure or mechanism may be used to manage the cache.

Some embodiments involve a method for obtaining location data from a server and caching the location data at the device. A geocoordinate (e.g., a latitude coordinate and a longitude coordinate) is obtained. A determination is made as to whether there is a cache hit based on the geocoordinate and the data stored in the cache. When there is a cache hit, the location is obtained from the cache on the device. When there is not a cache hit, a request is transmitted to the server for a location that is associated with the geocoordinate. A response is received from the server that indicates the location. The location received from the server is then stored in the cache.

The cache hit determination may be made in a variety of ways. In some implementations, for example, one or more proximity domains are generated. Each proximity domain is associated with one or more locations (e.g., an address, the name of a city, province, state, district, landmark, building, organization, business etc.) In various embodiments, each proximity domain helps indicate which geocoordinates are associated with the corresponding location. A determination is made whether there is a cache hit based on the proximity domains. There is a cache hit when the obtained geocoordinate is within a proximity domain In various embodiments, the proximity domain is based at least in part on an obtained geocoordinate, a cached geocoordinate or both. Some cache hit determinations involve a concave hull, a convex hull, a radius formed circle, implicit square hashing, r-tree partitioning, a spatial index or any other suitable technique.

Various implementations relate to mobile devices, servers and other systems that manage or store location data in a cache. Additional embodiments relate to various cache- or location-related software applications, methods and systems for sharing cache data, prepopagating a cache, correcting cache data and recommending locations.

### BRIEF DESCRIPTION OF THE DRAWINGS

The invention and the advantages thereof, may best be understood by reference to the following description taken in conjunction with the accompanying drawings in which:

FIG. 1 is a block diagram illustrating a communications system including a mobile device and a server according to a particular embodiment of the present invention.

FIG. 2 is a flow diagram of a method for managing a location cache on a mobile device according to a particular embodiment of the present invention.

FIG. 3 is a diagram illustrating example content of a cache according to a particular embodiment of the present invention.

FIG. 4 is a flow diagram of a method for generating and using a proximity domain according to a particular embodiment of the present invention.

FIGS. 5, 6A, 6B and 7 are diagrams illustrating example cache hit determination schemes according to various embodiments of the present invention.

FIG. 8 is a flow diagram of a method for a location tracking application according to a particular embodiment of the present invention.

FIG. 9 is a flow diagram of a method for a photo application according to a particular embodiment of the present invention.

FIG. 10 is an example user interface for a photo application according to a particular embodiment of the present invention.

FIG. 11 is a flow diagram of a method for recommending geocoordinates and/or locations according to a particular embodiment of the invention.

FIG. 12 is a flow diagram of a method for prepropagating a location cache on a device according to a particular embodiment of the present invention.

FIGS. 13A, 13B, 13C are diagrams illustrating how regions may be computed according to a particular embodiment of the present invention.

FIG. 14 is a diagram illustrating a device moving towards alternative locations according to a particular embodiment of the present invention.

FIG. 15 is a diagram illustrating multiple networked devices according to a particular embodiment of the present invention.

FIG. 16 is a flow diagram of a method for sharing cache data between multiple devices according to a particular embodiment of the present invention.

FIG. 17 is a flow diagram of a method for sharing cache data between multiple devices according to another embodiment of the present invention.

FIG. 18 is a flow diagram of a method for selecting and accessing a cache of an external device according to another embodiment of the present invention.

FIG. 19 is a block diagram of a device according to a particular embodiment of the present invention.

FIG. 20 is a block diagram of a server according to a particular embodiment of the present invention.

In the drawings, like reference numerals are sometimes used to designate like structural elements. It should also be appreciated that the depictions in the figures are diagrammatic and not to scale.

### DETAILED DESCRIPTION

Some applications, such as life logging and tourism applications, frequently make reverse geocoding requests to servers. By way of example, to determine whether a mobile device has arrived at a particular city or other known administrative region, a conventional mobile device makes a server call to request the conversion of a geocoordinate (e.g., a GPS-derived longitude/latitude coordinate pair) into a recognizable location name (e.g., Los Angeles, San Francisco, 75 W. Plumeria Dr., etc.)

Frequent reverse geocoding requests increase network delay and battery consumption. Various embodiments of the present invention address this issue. More specifically, location data is cached on the mobile device. When the mobile device next requires the reverse geocoding of a geocoordinate, the mobile device checks the cache to see if the location is stored there. If not, the mobile device consults with a server. Once the server provides the desired location, the location is then stored at the mobile device so that it may be accessed again in the future. Given that a typical person tends to spend the majority of their time within a relatively limited area, the likelihood of cache hits is quite high once the cache is partially filled with previously visited locations. By reducing the need for server calls, the use of a cache helps to greatly reduce bandwidth and battery consumption.

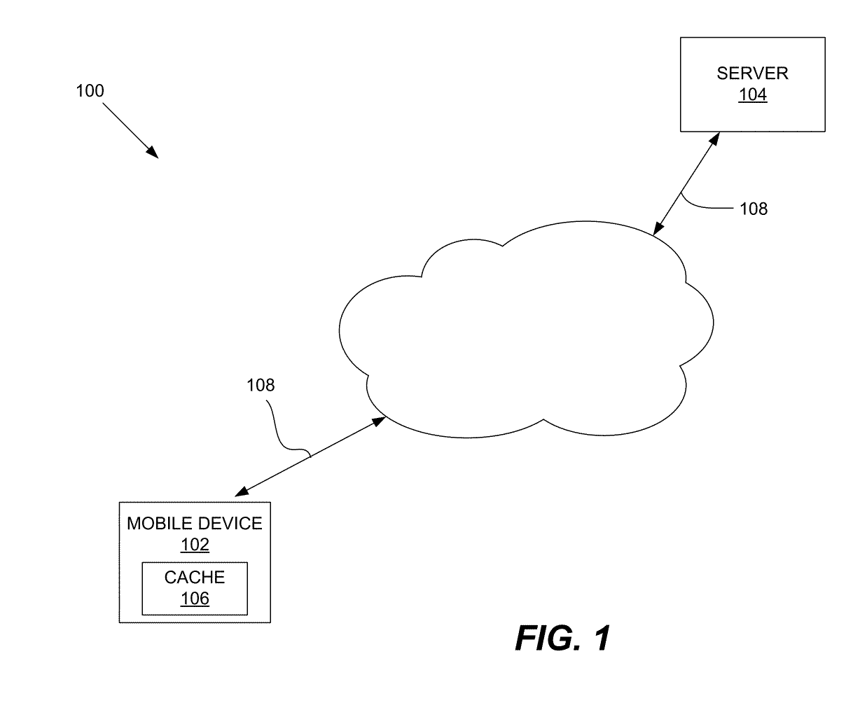

Referring initially to FIG. 1, a communications system 100 according to a particular embodiment of the present invention will be described. The system includes a device 102 and a server 104. The device 102 and server 104 communicate with one another using one or more networks. The device also includes a location cache 106. The mobile device 102 utilizes the communications system 100 to transmit reverse geocoding requests and to obtain location data from the server 104.

Any suitable network 108 may be used to connect the device 102 and the server 104. In various embodiments, the network involves but is not limited to a cellular network based on CDMA or GSM, the Internet or any other suitable protocol or any other communication network.

In this particular example, the mobile device 102 is running an application that is attempting to determine its current location. There are many types of mobile applications that require identification of one or more locations. For example, the user may be running a program that is supposed to inform the user when the user has entered a new city or has arrived at a particular landmark.

Generally, when a location is desired, the device 102 will check the cache 106. If the cache 106 cannot provide the desired location, the device 102 will make a server call using the network 108. The device 102 will then obtain the desired location data from the server 104 and will store it in the cache 106. Over time, the cache will collect data related to multiple locations. When these locations are visited again, location data can be retrieved from the cache, rather than from the server. This reduction in the number of server calls helps reduce bandwidth and power consumption. A more detailed discussion of a method for using the cache 106 and the communications system 100 is described below.

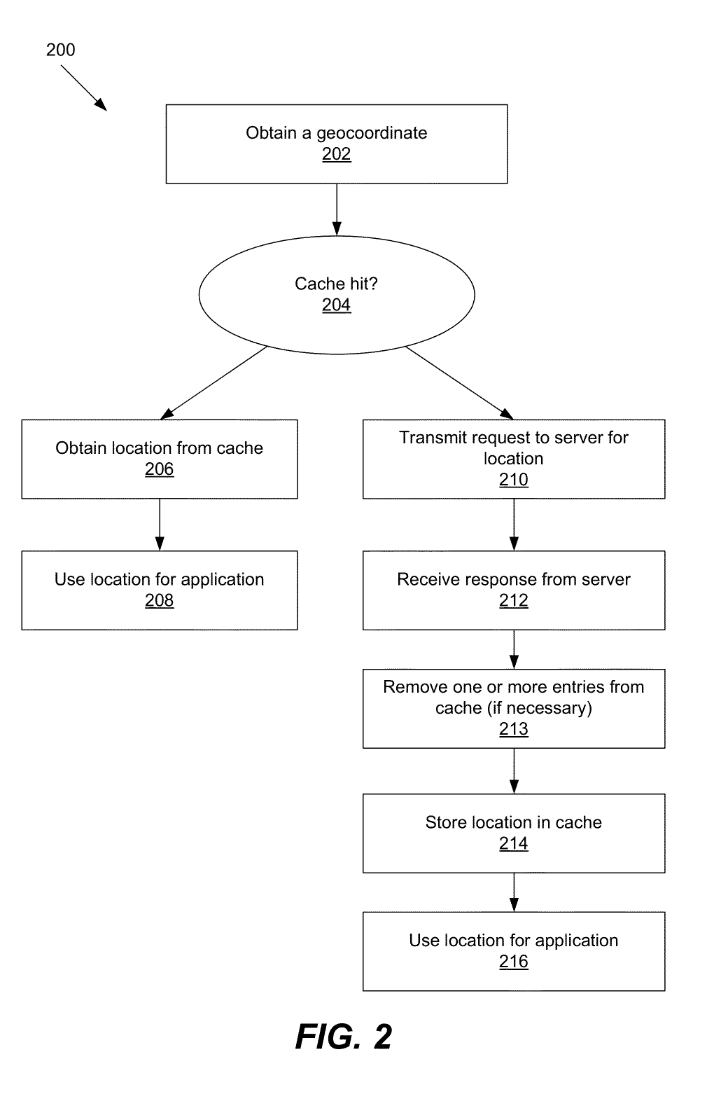

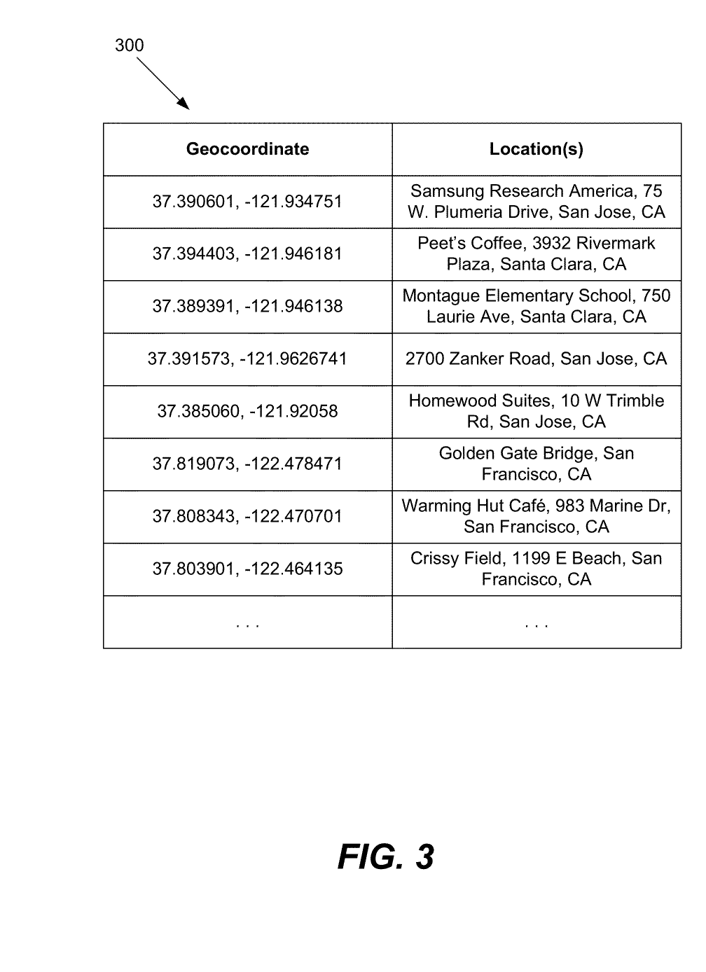

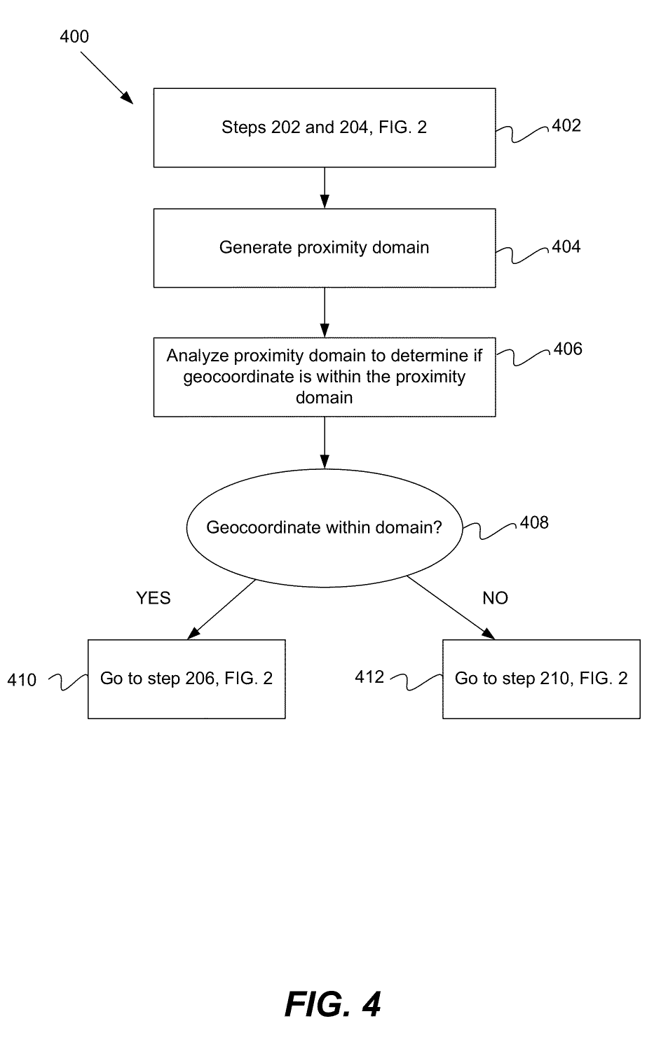

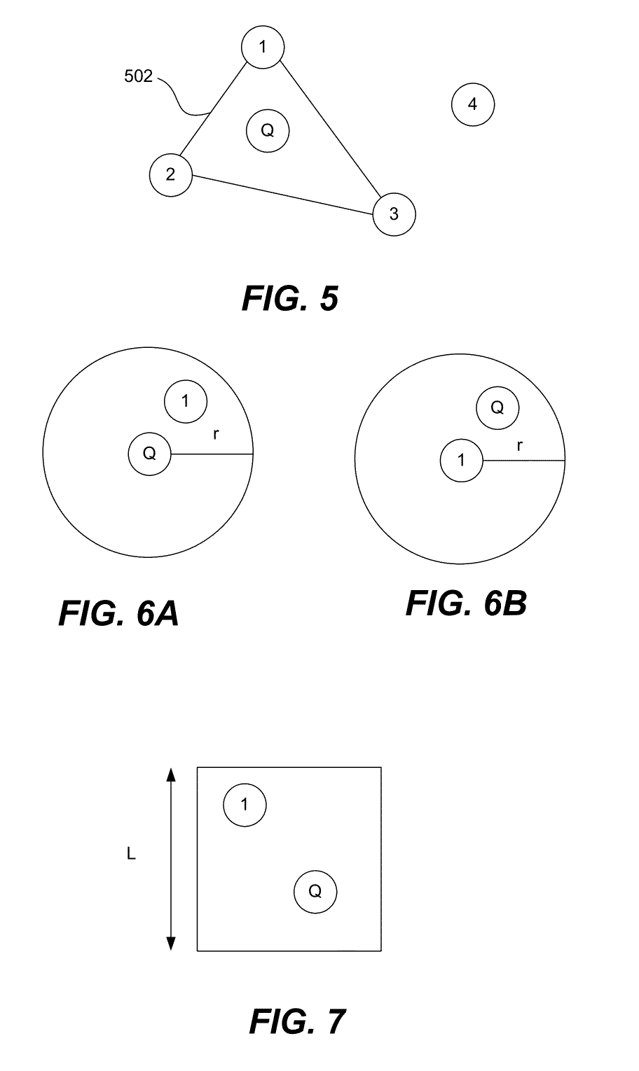

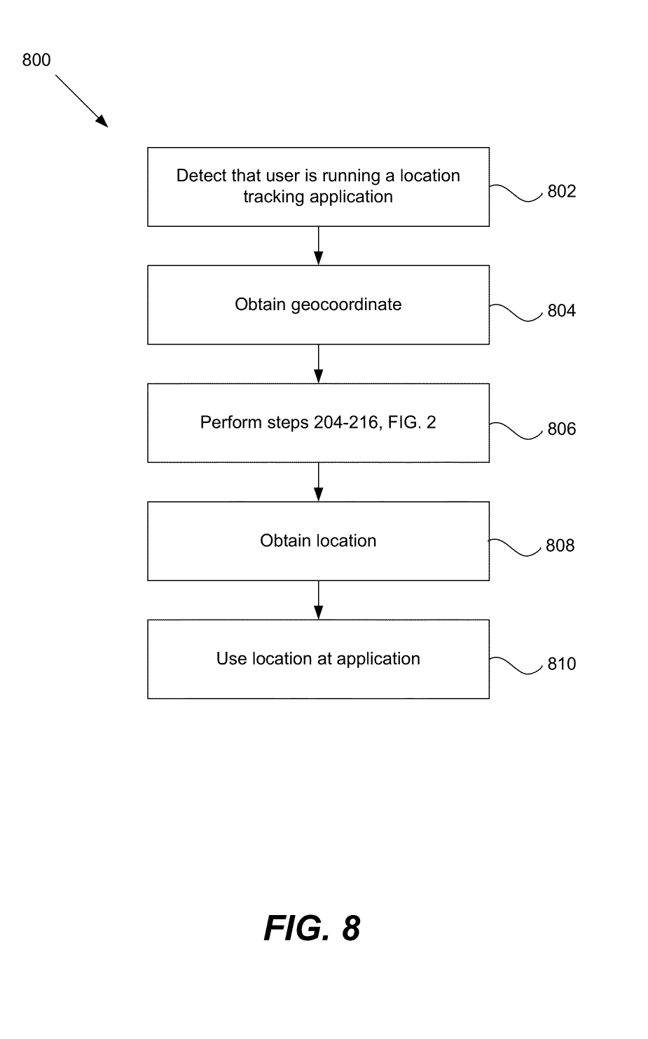

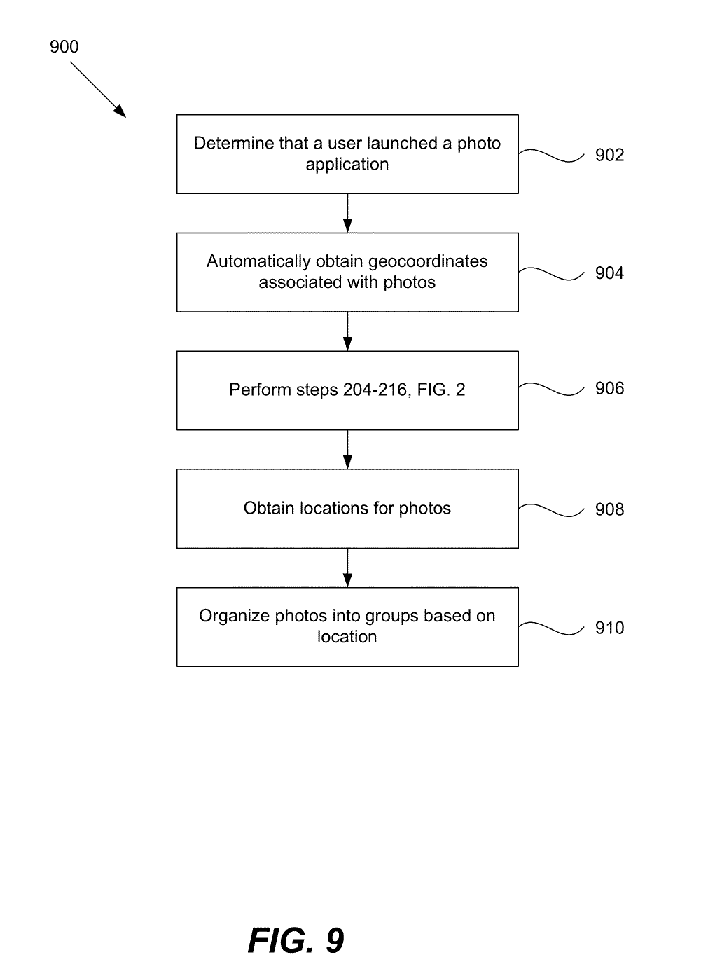

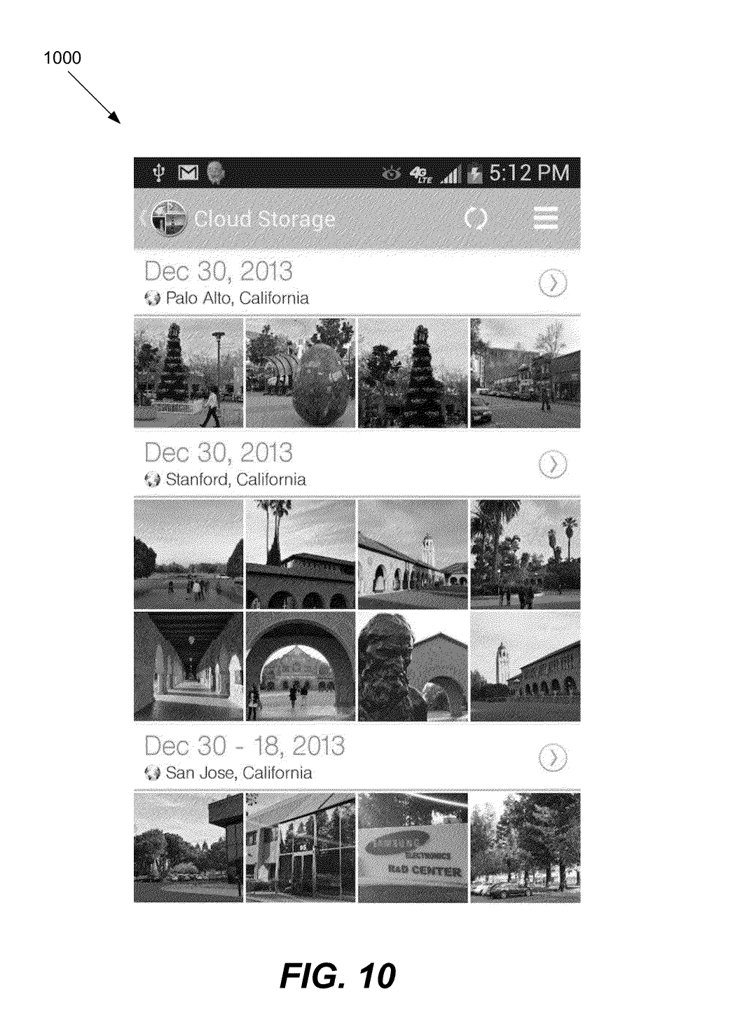

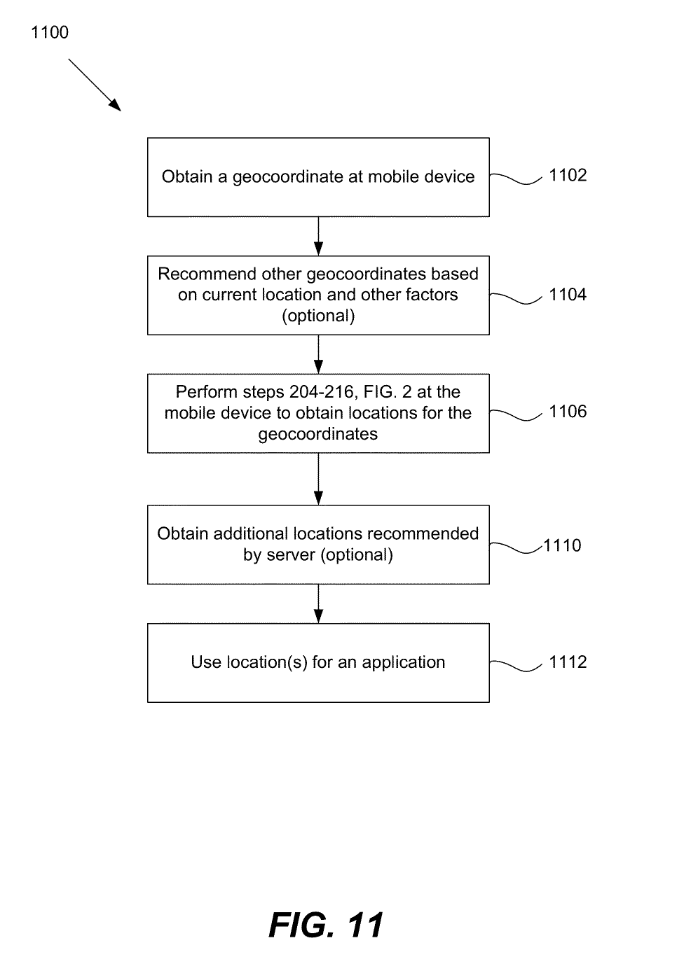

Referring next to FIG. 2, an example method 200 for obtaining a location using a cache 106 and the system of FIG. 1 will be described. Initially, at step 202, a geocoordinate is obtained. A geocoordinate is one or more codes, sequences, coordinates, symbols or mechanisms that help identify or point to a particular location. In various implementations, the geocoordinate is part of a larger coordinate/mapping system that maps or covers a target area. For example, latitude-longitude coordinates are part of a geographic coordinate system that covers the entire world. In that system, each specific geocoordinate pinpoints a particular point or location in the world. Generally, a geocoordinate is coded or written in such a way that the name of the location (e.g., a street address, the name of a landmark, the name of a city, etc.) that the geocoordinate refers to is not immediately recognizable to a layperson until the geocoordinate is further translated or analyzed. A process for determining the location(s) that a gecoordinate is associated with is generally referred to as reverse geocoding.

In the illustrated embodiment, the geocoordinate is a pair of coordinates i.e., the latitude and longitude coordinates that are obtained with the help of a GPS satellite. That is, mobile device 102 includes a GPS receiver that receives data from multiple GPS satellites. In this example, the mobile device uses triangulation to help determine the correct latitude and longitude coordinates that correspond to a particular location on the globe, although any suitable system may be used to obtain the geocoordinate. In this particular example, the mobile device obtains a geocoordinate that corresponds to latitude and longitude coordinates 37.803901 and −122.464135.

Once a geocoordinate is obtained, a determination is made as to whether there is a cache hit (step 204). That is, the mobile device 102 determines whether the location associated with the obtained geocoordinate can be found in the cache 106. The cache 106 is any mechanism or system for storing location data at the mobile device 102. Generally, the cache 106 is arranged to help indicate which geocoordinates correspond to one or more locations. The cache 106 may involve any known cache format or structure.

The cache hit determination of step 204 may be performed in a wide variety of ways, depending on the needs of a particular application. In some embodiments, for example, the cache 106 includes entries that each associate a particular geocoordinate or geocoordinate ranges with one or more locations. In some applications, a cache hit may require an (almost) exact match between the geocoordinate obtained in step 202 and a geocoordinate stored in the cache. In other applications, a relationship between data or a geocoordinate in the cache and the obtained geocoordinate is inferred, which results in a cache hit. That is, an exact geocoordinate match is not required. Various example techniques will be discussed later in the application.

If there is not a cache hit i.e., if the cache is unable to provide a location associated with the obtained geocoordinate, then a request is transmitted to a server for a location associated with the obtained geocoordinate (step 210). The mobile device generally transmits the geocoordinate over the network to the server 104.

The server 104 determines the corresponding location and transmits it to the mobile device 102. In some embodiments, the server 104 performs the reverse geocoding using a known mapping service, such as Google Maps or OpenStreetMap. In this particular example, the server 104 determines that the latitude and longitude coordinates 37.803901 and −122.464135 correspond to the city of San Francisco.

In various embodiments, the server 104 provides multiple locations in response to a reverse geocoding request. In some cases, the multiple locations represent multiple overlapping administrative regions or areas. In the illustrated embodiment, for example, the server 104 determines not only that the geocoordinate 37.803901, −122.464135 represents the city of San Francisco, but also are located in the state of California, are at 1199 East Beach, and are at a location called Crissy Field, which is a popular recreational area at the northern end of San Francisco. All of these locations are then sent to the mobile device 102. Alternatively or additionally, in various implementations the server returns recommended locations that might be of interest and/or are in the vicinity of the device, even if the mobile device 102 has not yet visited those locations. The identification of these recommended locations may be based on a variety of factors, including but not limited a user profile, a history of user actions and movements and any other data stored on the mobile device 102 or the server 104.

In the illustrated embodiment, the server 104 transmits the above location(s) to the mobile device 102. Optionally, the server 104 also transmits a geocoordinate that is associated with each location or set of locations. The exact format of the transmitted location data may vary widely. In some implementations, for example, the transmitted data includes one or more entries, in which each entry involves a single geocoordinate (e.g., a pair of latitude-longitude coordinates that specifies a particular point on the globe) and one or more locations that the geocoordinate corresponds to.

The mobile device 102 receives the one or more locations from the server 104 (step 212) and prepares to store them in the cache 106 (step 214). If the cache 106 is full and/or under selected other conditions, the mobile device 102 optionally removes one or more entries from the cache (step 213) to increase the storage capacity of the cache 106.

The removal of a cache entry may be performed in a variety of ways, depending on the needs of a particular application. In some embodiments, for example, the least recently used entry is removed first (i.e., the entry that has not been involved in a cache hit for the longest period of time.) In other embodiments, the least frequently used entry is removed first. In still other embodiments, the cache entry that corresponds to a location that is farthest from the current position of the mobile device is removed. Some implementations involve removing an associated group of cache entries, rather than just one. For example, if the mobile device 102 determines that the user is leaving a city and/or determines that a particular city has not been visited for a long period of time, then some or all of the entries in the cache that correspond to locations in the city are removed. In various embodiments, the mobile device determines that when a particular cache entry is removed (e.g., based on a least recently used (LRU) or least frequently used (LFU) policy), all cache entries that have a particular type of relationship with the cache entry are also removed. Any suitable type of relationship may trigger removal of the cache entry. For example, if a cache entry related to a location A in San Francisco is to be removed, the mobile device may also remove entries in the cache that correspond to any location within a predetermined distance of location A or that are frequently visited by people who also visit location A. It should be appreciated that any known cache algorithm, structure or mechanism may be used to insert entries into, remove entries from or otherwise operate the cache.

At step 214, the mobile device 102 stores the location data received from the server 104 in the cache 106. The data that is stored in the cache 106 and its format may vary widely. Any known cache structure, spatial index or algorithm may be used to store and organize the location data. The cache may be part of the mobile device 102 or be separate from the device (e.g., an external storage device, online storage, etc.) In some embodiments, an index value is computed and the location data is stored in a spatial indexing structure or any other suitable structure using the index value.

One example embodiment is illustrated in FIG. 3. In this example, the cache 106 stores multiple entries in which each entry includes a geocoordinate (in the form of a latitude and longitude coordinate pair) and location(s) that the coordinate pair represents or corresponds to. In FIG. 3, each entry of the cache indicates a geocoordinate that was previously obtained in step 202 and locations that were previously visited by the device 102, but this is not a requirement. By way of example, in some applications, the cache 106 includes entries that do not represent past movements of the device, but instead were obtained from another device or the server.

At step 216, the application running on the mobile device makes use of the location data received from the server. In this example, the mobile device is running a program that regularly notifies the user of changes in the location of the device. The mobile device thus notifies the user (e.g., using audio and/or a notification on its display) that the user has arrived at Crissy Field, which is located at 1199 E Beach, San Francisco, Calif.

Returning to step 204 of FIG. 2, if it is determined that there is a cache hit, then the location data is obtained from the cache 106 (step 206). That is, a server call is not required or performed and the location data is obtained locally. In various implementations, when there is a cache hit, a new entry for the geocoordinate obtained in step 202 is not added to the cache 106. This may be the case even though the obtained geocoordinate is different from any geocoordinate stored in the cache 106. This situation can arise, for example, when a cache hit is inferred and does not involve an exact match between the obtained geocoordinate and a cached geocoordinate e.g., as previously discussed with respect to FIGS. 5, 6A and 6B.

The type of location data received from the cache may be the same or similar to the location data that would have otherwise been received from the server in response to a reverse geocoding request (i.e., the location data received from the server in step 212.) Thus, the location data may include one or more locations, including but not limited to an address, a name of a building, name of a street, name of a city or other administrative region, etc. At step 208, the one or more locations obtained from the cache are used in an application on the device (e.g., as discussed in step 216).

In some implementations, a user can correct erroneous cache entries. For example, assume that the mobile device 102 obtains a geocoordinate (step 202), determines that there is a cache hit (step 204), and obtains a location from the cache (step 206). The location is obtained from a particular cache entry in the cache that is inferred to be applicable to the obtained geocoordinate. The cache entry is associated with a particular location (e.g., Daly City.) In this example, the location is intended to represent the current location, which an application displays to the mobile device user. However, the mobile device user may discover that the cited location is incorrect (e.g., the user may know he or she is in San Francisco, but the location provided by the cache indicates Daly City, which is south of San Francisco.) In some applications, the user can then input the correct location (e.g., San Francisco) into a user interface of the mobile device 102. The mobile device 102 then corrects the erroneous cache entry with the correct location name.

Referring next to FIG. 4, a method 400 for determining a cache hit according to a particular embodiment of the present invention will be described. This method provides an example technique for determining a cache hit as described in step 204 of FIG. 2. Initially, the first two steps of method 200 of FIG. 2 are performed (step 402). That is, one or more geocoordinates are obtained (step 202 of FIG. 2) and the cache is accessed to determine if a cache hit has occurred (step 204 of FIG. 2).

The cache hit determination may be performed in a wide variety of ways, depending on the needs of a particular application. In some embodiments, for example, one or more proximity domains are generated (step 404). Generally, each proximity domain is associated with one or more locations (e.g., names of cities, landmarks, addresses, etc.) The proximity domain is any suitable domain, range, algorithm, structure, scheme or mechanism that helps determine whether a particular geocoordinate refers to the associated one or more locations. In some implementations, for example, a proximity domain helps define a range or set of geocoordinates (e.g., latitude and longitude coordinates). If a particular gecoordinate falls within the proximity domain, then the geocoordinate is assumed to refer to the same location(s) that are associated with the proximity domain. At step 406, the one or more proximity domains are analyzed to determine if the geocoordinate(s) obtained in step 202 of FIG. 2 are within one of the proximity domains.

FIGS. 5, 6A, 6B and 7 refer to several example proximity domain types and cache hit determination techniques. It should be appreciated that these approaches are exemplary and not intended to be limiting. They may be modified as appropriate and that any known type of proximity domain or cache determination technique may be used.

Referring to FIG. 5, a convex hull 502 is used to make a cache hit determination. An example process for using a hull may be described as follows. In the illustrated embodiment, geocoordinates 1, 2, 3 and 4 are stored in the cache and thus represent known locations. They may also represent geocoordinates that the device has already visited and/or obtained in step 202 of FIG. 2, although this is not a requirement. For the purpose of this example, it is assumed that geocoordinates 1, 2 and 3 each is a pair of latitiude-longitude coordinates that are associated with and represent locations in San Francisco, Calif. Point 4 is assumed to be a latitude-longitude coordinate that is associated with a different location outside of San Francisco.

Since cached geocoordinates 1, 2 and 3 are known to correspond to San Francisco, it is assumed that a hull 502 that is drawn to connect the three points will define a proximity domain that also is associated with San Francisco. That is, any geocoordinate that falls within the hull 502 is assumed to also be associated with San Francisco. Assume that the point Q refers to a new geocoordinate obtained in step 220 of FIG. 2. If that is the case, then a cache hit will be found, because geocoordinate Q is within the hull 502 defined by other cached geocoordinates 1, 2 and 3. However, if point Q fell outside of any hull defined by the cached geocoordinates, then in some embodiments it will be determined that there is a cache miss i.e., that a location could not be acquired from the cache and that a server call is required.

FIGS. 6A and 6B utilize a somewhat different type of proximity domain In the illustrated embodiments, for example, the proximity domain is defined by a distance or radius from either a cached geocoordinate or the new geocoordinate (i.e., the geocoordinate obtained in step 202 of FIG. 2.) In FIG. 6A, the cache hit determination process involves determining whether there are any cached geocoordinates within a predetermined radius r of the new geocoordinate Q. In this example, there is one such cached geocoordinate, which is designated as geocoordinate 1 in the figure. In this case, it is assumed that there is a cache hit and that the new geocoordinate corresponds to the same location as the cached geocoordinate 1. That is, if the cached geocoordinate 1 is associated with the city of Los Angeles, then it would be assumed that the new geocoodinate is also associated with and also involves a location in the city of Los Angeles. If the new geocoordinate Q is not within a radius r of any cached geocoordinate, then in some embodiments it is determined that there is a cache miss.

In FIG. 6B, the center of the radius-formed circle is a cached geocoordinate, rather than the new geocoordinate. That is, a determination is made as to whether the new geocoordinate Q is within a radius r of any of the cached geocoordinates. In the illustrated example of FIG. 6B, the geocoordinate Q is within a radius r of the cached geocoordinate 1, and thus it is determined that there is a cache hit. In that case, the location associated with cached geocoordinate 1 is assumed to be the location associated with the new geocoordinate Q. If the new geocoordinate Q is not within a radius r of any of the cached geocoordinates, in some embodiments it is assumed that there is a cache miss.

FIG. 7 represents still another way of defining a proximity domain and making a cache hit determination. This approach is based on the concept that an area or geographical region can be divided up into adjacent squares with a length L. Each square is associated with one or more locations (e.g., city name, state name, address, etc.) That is, each square defines a universe or domain of geocoordinates that all are associated with the same location. One or more of these squares may be cached at the mobile device using any suitable value, format or structure. To determine whether there is a cache hit, the cached squares and the new geocoordinate are analyzed. If a new geocoordinate is found within one of these cached squares, then it is assumed that there is a cache hit. That is, it is assumed that the new geocoordinate represents or involves the same location as the location represented by the square.

The above approach may be implemented in a variety of ways. In the illustrated embodiment, for example, each square with a side length L is represented by a geocoordinate (e.g., a pair of latitude-longitude coordinates.) The length L of the square determines the precision of each coordinate, and thus the number of digits or decimal places in the coordinate. Any geocoordinate that is to be stored in the cache (e.g., similar to the cache of FIG. 3) is thus shortened to the designated number of decimal places and hashed before it is stored in the cache. When a new geocoordinate (i.e., as described in step 202 of FIG. 2) is obtained, it is also shortened to the same number of decimal places and hashed. If there is a match between hashes of the new geocoordinate and any cached geocoordinate, then it is assumed that there is a cache hit. Thus, the location associated with the cached geocoordinate is assumed to be the same location that is associated with the new geocoordinate. If no such matches are found in the cache, it assumed that there is a cache miss and that a server call is necessary.

It should be appreciated that the cache hit determination process is not limited to the techniques described above. Any know spatial index, algorithm and/or scheme may be used to structure the cache 106 and/or to determine whether a cache hit has taken place. In some embodiments, for example, the cache hit determination and/or the proximity domain involves R-tree partitioning, k-D trees, quadtrees or any other suitable tree or structure.

In some situations, there may be more than one cache hit for a particular geocoordinate. For example, a new geocoordinate may fall within more than one convex hull or more than one circle defined by a radius that extends from a cached geocoordinate. In that situation, any suitable algorithm or decision process may be used to select which proximity domain and which location should be associated with the new geocoodinate. In some embodiments, for example, a proximity domain or associated location is selected based on a distance measurement or proximity (i.e., if the new geocoordinate falls within two circles of radius r defined by cached geocoordinates A and B, respectively, then the new geocoodinate is assumed to be associated with the same location as the closer geocoordinate.)

It should be noted that in some embodiments, the proximity domain (e.g., hulls, circles, geocoordinate ranges, other suitable cache hit determination algorithms or structures etc.) is generated and/or defined at the mobile device, not at a reverse geocoding server or another external device. This offers several advantages. For one, the mobile device can redefine the basis for the cache hit determination dynamically, without requiring input from another device. Additionally, an external device, such as a server, does not need to transmit the proximity domain to the mobile device.

Returning to FIG. 4, once the proximity domain(s) is generated and analyzed, a determination is made as to whether the geocoordinate (i.e., the geocoordinate obtained in step 202 of FIG. 2) is within one of the proximity domains (step 408). If so, there is a cache hit, and it assumed that the obtained geocoordinate is associated with the same location that is associated with the corresponding proximity domain. In this case, the method continues to step 206 of FIG. 2 (step 410). If there is no cache hit, then the method continues to step 210 of FIG. 2, so that a server request can be sent to obtain location information (step 412).

Referring next to FIG. 8, an example method 800 for using a location cache for a tracking application will be described. Initially, at step 802, the mobile device 102 detects that the user is running a location tracking application. There are a wide variety of possible location tracking applications. Generally, such applications involve automatically tracking a device and its user when a particular action is taken or as the user is moving from place to place. Some of these applications include but are not limited to a life logging application, a tourism application and a geofencing application.

At step 804, a geocoordinate is obtained. This is performed in generally the same manner as step 202 of FIG. 2. Generally, this geocoordinate reflects or represents the current location of the mobile device. The timing of the obtaining of the geocoordinate depends on the nature of the application. For example, a life logging application is an application that stores entries in the form of photos, video, text and audio. The entries over time effectively form a digital diary. Each entry is typically automatically dated. In addition, after an entry is completed or saved at the application, the mobile device 102 then automatically obtains a geocoordinate (step 804) so that the location where the entry was created can also be stored and associated with the entry. For example, if a log entry was entered at the time that the geocoordinate 37.390601, −121.934751 was obtained, the life logging application would mark the log entry as being made in San Jose, Calif.

In some tourism applications, the application is arranged to notify the user when his or her device arrives at particular locations, cities or landmarks. When the device 102 arrives at specific locations, the application may give an audio tour of the location or describe features of the location. Thus, such applications may frequently and regularly attempt to obtain geocoordinates (step 804), in order to ensure that the location of the user is well known and so that opportunities to describe or explain notable features of particular locations are not missed. A similar functionality is available on some audio guides for the blind, which track a blind user's movement and give audio instructions depending on what locations (e.g., addresses, cross walks, street corners, buildings, etc.) the user is at.

Geofencing applications also can make use of the aforementioned technologies. Geofencing applications typically require a user to define conditions for a message or notification. For example, a user might configure the application to tell him to buy milk when he arrives at a supermarket in Cupertino, Calif. After the user inputs the conditions and notification into the application, the application frequently and automatically obtains geocoordinates (step 804) to determine whether the user is at the supermarket or another location. Once the application determines that the user is at the designated location (e.g, the supermarket), the application notifies the user of the desired reminder (e.g., to buy milk)

Once the geocoordinate is obtained, steps 204, 206, 208, 210, 212, 214 and 216 of FIG. 2 are performed as appropriate, depending on whether there is a cache hit or not (step 806). If there is a cache hit for the geocoordinate, then a location can be drawn from the cache 106. If there is a cache miss, the location is retrieved from a server 104 (step 808). Afterward, the application uses the location as described above (step 810). For example, a tourism application or a tour guide application for the blind may notify the user that a particular location has been reached. If method 200 of FIG. 2 determines that the user of a geofencing application has arrived at a designated location, the application will then notify the user (e.g., through an audio signal and/or a displayed message) of the message that the user had provided to the application earlier.

Referring next to FIG. 9, an example method 900 for using a location cache for a photo application will be described. Initially, at step 902, the mobile device determines that the user of the device is running a location-based photo application.

Various photo applications have access to multiple photos stored at the mobile device 102 or on a remote server 104 that the mobile device 102 has access to. Each photo may be stored in any suitable file format (e.g., TIFF or JPEG). Each photo file typically also contains metadata that includes a geocoordinate (e.g., a latitude-longitude coordinate pair), which represents where the photo was taken. However, further analysis or conversion of the geocoordinate is needed to determine which city, landmark, building or other locations those coordinates refer to. Once these locations are identified, the photos can be arranged by location. For example, a user could easily and automatically place all the photos taken in one city in one folder, and all the photos taken in another city in another folder.

When the user launches the photo application and/or activates a feature for sorting photos by location, the application on the mobile device 102 automatically obtains the geocoordinates for the photos (step 904). Afterward, a location is associated with each photo based on the geocoordinate for that photo. The location is determined using the steps of method 200 of FIG. 2 (step 906). That is, for each photo geocoordinate, a cache hit determination is made and steps 206, 208, 210, 214 and 216 of FIG. 2 are performed accordingly to determine a location associated with the photo geocoordinate. Depending on whether there is a cache hit or not, the geocoordinate may have to be reverse geocoded using a server call. After the method 200 is implemented, a location should be known for each photo (step 908). Afterward, the locations are organized into groups based on location (step 910).

An example implementation is shown in FIG. 10. FIG. 10 is an example user interface 1000 for a photo application, which is displayed on the screen of a mobile device 102. The user interface 1000 displays the results of the performance of step 910. In this example, the photos are organized by city. More specifically, the top row of photos all are associated with photo geocoordinates that are in the proximity domain for Palo Alto, Calif. That is, the top row of photos were all taken in Palo Alto. Similarly, the photos in the middle and bottom rows were taken in Stanford, Calif. and San Jose, Calif., respectively.

Referring next to FIG. 11, a method 1100 for obtaining multiple locations according to another embodiment of the present invention will be described. That is, the mobile device 102 and/or server 104 recommends additional geocoordinates and/or locations. Additional locations may be stored in the location cache, and additional geocoordinates may be handled using the aforementioned cache hit determination and reverse geocoding techniques.

Initially, a geocoordinate is obtained at the mobile device (step 1102). This step may be the same or similar to step 202 of FIG. 2. For example, a user may be using a location tracking or tourism application at the mobile device, as previously discussed in connection with FIG. 8. In this example, an application on the mobile device 102 automatically obtains a geocoordinate to determine the current position of the user.

In some applications, it is desirable to automatically obtain one or more additional geocoordinates based on the current location and/or a variety of other factors. That is, the mobile device 102 recommends additional geocoordinates other than the geocoordinate that represents the current location of the mobile device (step 1104). The selection of the recommended geocoordiates may be based on a variety of factors, including but not limited to a user profile stored on the mobile device, user interests, geocoordinates obtained in the past by the mobile device or geocoordinates obtained in the past by other devices, or any data stored in the mobile device 102.

Consider an example in which a user is accessing and running a tourism application on the mobile device 102. The tourism application obtains data from a GPS satellite and obtains a geocoordinate that reflects the current location of the mobile device. The application then analyzes data stored on the mobile device (e.g., user profile, user activity history, data received from other devices or a server, etc.) and determines that in the past, the user visited or might be interested in two additional locations identified by two other geocoordinates. The geocoordinates represent locations that are in the vicinity of or within a predetermined distance of the user. Based on these factors, the tourism application then recommends these additional geocoordinates.

Once the mobile device 102 obtains a geocoordinate representing its current location as well as other recommended geocoordinates, the mobile device 102 determines the locations associated with these geocoordinates. That is, the mobile device performs the steps of method 200 of FIG. 2 to obtain the associated locations for the geocoordinates (step 1106).

As previously discussed in connection with method 200, there may not be a cache hit for one or more of the geocoordinates. In that case, the mobile device 102 sends a request to the server 104 for the location. As previously discussed, the server 104 then responds with the associated location. However, in some cases, the server response will also optionally include additional locations that the server recommends. These recommended locations are selected based on any suitable data stored on the server, including but not limited to a history of the movement of different mobile devices to different locations and a database of known landmarks, notable locations, organizations or buildings in the vicinity of the mobile device 102.

Consider the above example, in which the user is running a tourism application on the mobile device 102. The tourism application receives data from a GPS satellite and obtains a geocoordinate (i.e., a pair of latitude-longitude coordinates) that represent the current location of the mobile device (step 1102). In this example, the coordinates are 37.803901, −122.464135. There is no cache hit for this geocoordinate, so the tourism application transmits the geocoordinate to the server (step 1106). The server 104 determines that the geocoordinate is associated with Crissy Field, 1199 E Beach, San Francisco, Calif. Crissy Field is a popular walking area along the northern end of San Francisco. The server 104 then determines whether there are other locations that the user might be interested in. The server 104 consults its internal database and determines that there are several notable places within a predetermined distance of the geocoordinate. The locations are the Warming Hut Café, which is a popular café near Crissy Field and the Golden Gate Bridge, which is a popular nearby tourist destination.

The server 104 may identify such recommended locations in a variety of ways. In various embodiments, for example, the server 104 receives numerous reverse geocoding requests from different mobile devices. An analysis of the reverse geocoding requests and their associated geocoordinates can reveal, for example, that many mobile devices and their users spend substantial amounts of time at the Warming Hut Café and the Golden Gate Bridge. The server can draw upon this data to make its recommendations.

In the above example, the server 104 thus sends the location associated with the geocoordinate obtained by the mobile device (i.e., Crissy Field, 1199 E Beach, San Francisco, Calif.) The server also transmits the following to the mobile device:
37.808343, −122.470701 Warming Hut Café, 983 Marine Dr, San Francisco, Calif.
37.819073, −122.478471 Golden Gate Bridge, San Francisco
   In addition to the above, in various embodiments the server transmits additional information associated with the locations e.g., a small description, photo and/or list of notable features of the Warming Hut Café, the Golden Gate Bridge and/or Crissy Field.

The mobile device 102 then receives the one or more locations recommended by the server (step 1110). The mobile device 102 stores locations received from the server in the cache 106. If the mobile device received additional supplementary information (e.g., descriptions, photos, etc.), this data is stored in memory for later use.

The mobile device then uses the location(s) in an application (step 1112). In the above example, the mobile device 102, which is running a tourism application, then notifies the user that he or she is at Crissy Field. The mobile device 102 further recommends, based on the input received from the server, that there are two additional locations of interest nearby, including the Warming Hut Café and the Golden Gate Bridge. These notifications and recommendations can be conveyed, for example, by displaying an alert or explanatory text on a screen of the mobile device 102. Also, if the user does arrive at the Warming Hut Café, any reverse geocoding request for the current location can now be retrieved from the cache, rather than requiring a server call.

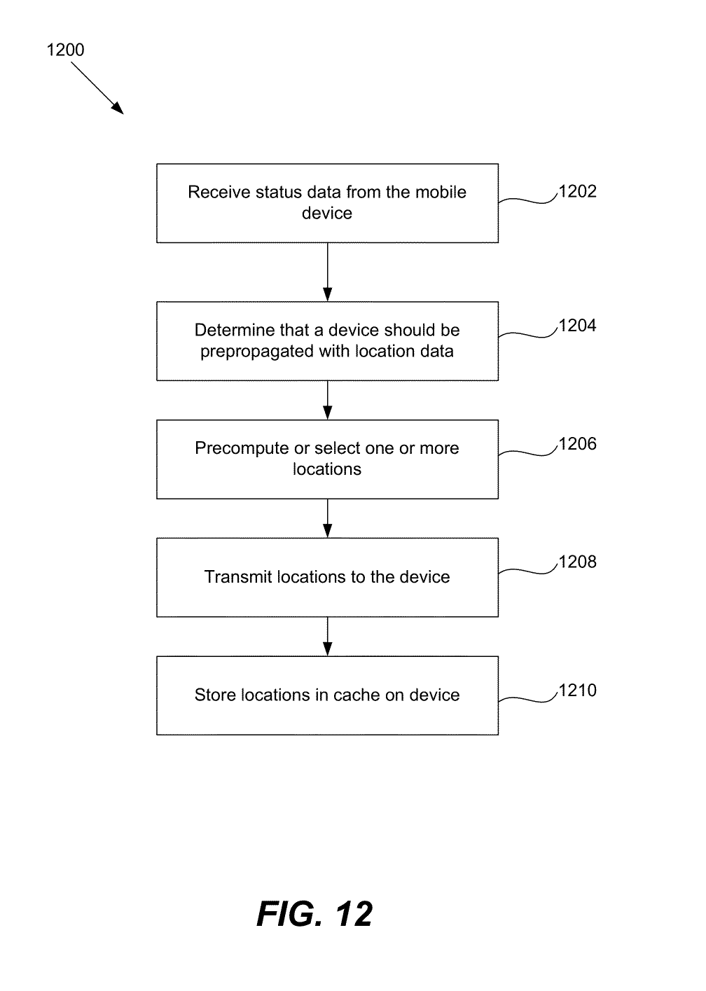

Referring next to FIG. 12, a method for pre-propagating a location cache according to a particular embodiment of the present invention will be described. In the illustrated embodiment, a server 104 performs method 1200 to prepopagate the cache on a mobile device 102. However, any suitable device that is capable of transmitting data to the mobile device 102 may be used in place of the server 104.

Under some circumstances, it is desirable to prepropagate a location cache on the mobile device 102. That is, the location cache is prefilled with entries, locations and/or geocoordinates that were not specifically requested or obtained by the mobile device 102. In many of the aforementioned examples, geocoordinates obtained by the mobile device 102 reflect current and past locations of the mobile device 102. Thus, the location cache was filled with data that reflected the past movement of the mobile device 102.

In some cases, however, it is useful to fill the cache with data this does not reflect the past activities or positions of the mobile device 102. For example, a newly acquired mobile device that has never been used may have an empty cache. As a result, as the mobile device moves between different locations, obtains geocoordinates and makes reverse geocoding requests, no or few cache hits will occur and many server calls will have to be made. This can be costly in terms of bandwidth and battery usage. In such cases, prepropagating the cash with relevant location data can provide significant benefits in terms of reduced network delay and power consumption.

Initially, at step 1202, the server 104 receives data from the mobile device 102 indicating its status (step 1202). The data may take a variety of forms. In some embodiments, for example, the mobile device 102 sends a signal to the server 104 indicating that the cache is empty or nearly empty and should be filled. Some implementations allow a user to configure the settings of the mobile device 102 so that prepropagation occurs only under selected conditions. By way of example, a user could configure the settings to indicate that prepropagation should only occur when there is a Wi-Fi connection, during a particular time of the day and/or when the battery of the mobile device 102 is charging. Additionally, the user could configure the settings to indicate that only a particular amount of storage will be made available for prepropagation, or that prepropagation should involve regions only within a particular predetermined distance of the device's current position. Additionally or alternatively, the mobile device 102 transmits a geocoordinate to the server indicating its current location. Any other data that helps the server 104 with the pre-propagation process (e.g., sensor data, a history of obtained geocoordinates, etc.) may also be transmitted from the mobile device 102 to the server 104 at this stage.

Based on the received data, the server 104 determines that the mobile device 102 should be prepropagated with location data (step 1204). At step 1206, the server 104 precomputes or selects one or more locations. The locations that are precomputed or selected are generally based on the data received from the mobile device 102. By way of example, if the mobile device has provided its current location, the server can precompute or select multiple locations that are adjacent to or within a predetermined distance of the mobile device 102.

The locations may be selected or precomputed in a variety of ways. In some embodiments, for example, the server 104 precomputes multiple, adjacent square regions that cover an area near the current location of the mobile device 102. By way of example, such regions may have any of the characteristics of the square described in connection with FIG. 7. That is, the square region can be represented by (hashed) latitude-longitude coordinates whose precision and number of decimal places has been limited based on the predetermined length of a side of the square region. However, it should be appreciated that the regions can be precomputed and configured in a wide variety of ways and are not limited to the square design described above.

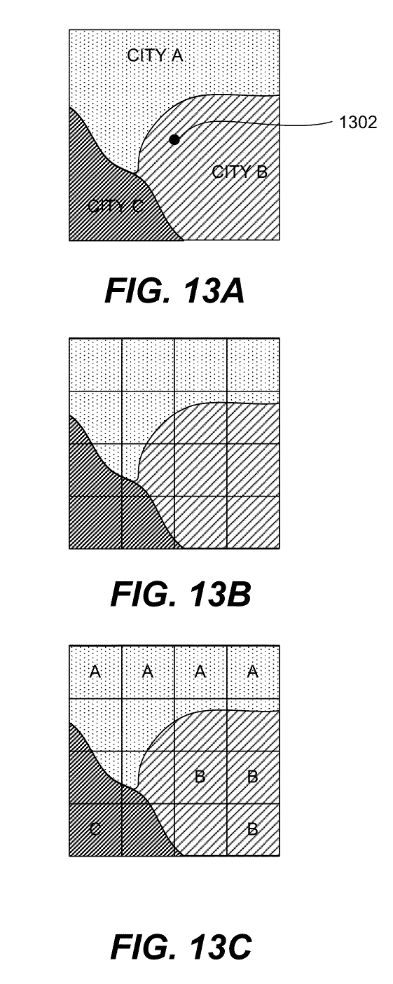

One example approach to generating regions is described in FIGS. 13A-13C. FIGS. 13A-13C indicate various steps in precomputing multiple regions. In this example, the server 104 receives a geocoordinate (step 1202) from the mobile device 102 indicating a current location 1302 of the mobile device 102. As indicated by FIG. 13A, the server 104 determines that there are one or more administrative regions (e.g., cities, counties, districts, regions provinces, etc.) in the vicinity of the current location 1302 of the mobile device 102. In the illustrated embodiment, the mobile device 102 is determined to be in the vicinity of three cities, which are marked cities A, B and C in FIG. 13A.

As shown in FIG. 13B, the server 104 then precomputes regions (e.g. squares with a predetermined length, as discussed in FIG. 7). Some of the squares cross over two administrative regions (e.g. cities), while other squares (squares marked A, B and C of FIG. 13C) are wholly contained within a single region. In various implementations, the server 104 transmits data indicating only the latter squares to the mobile device 102 for storage in the cache 106.

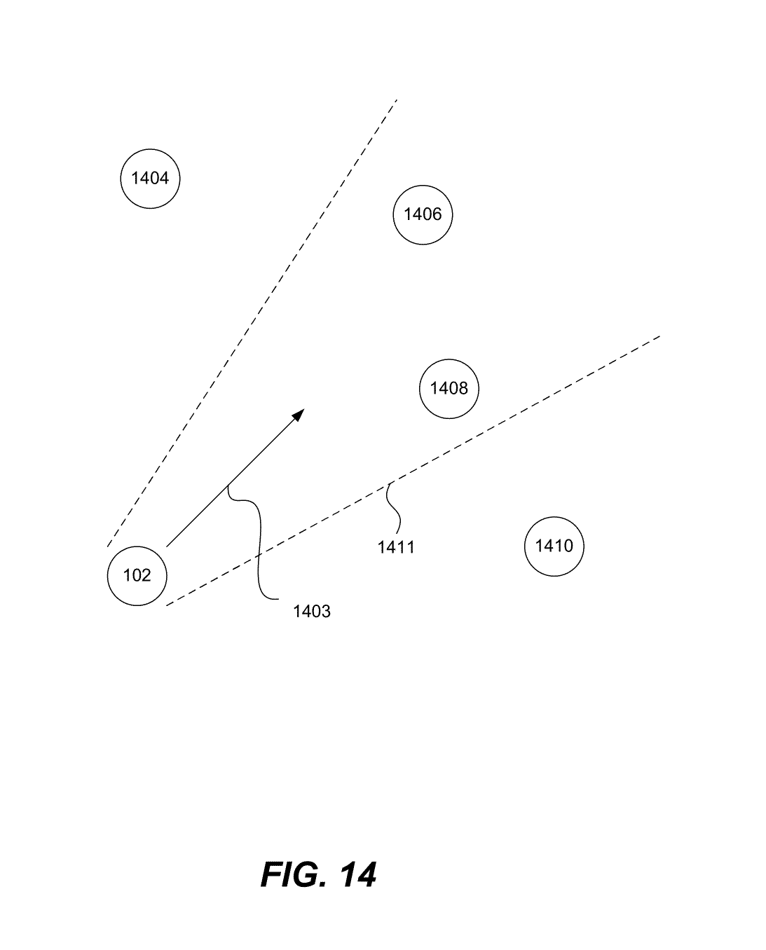

Another approach for determining prepropagation location data is illustrated in FIG. 14. In FIG. 14, a mobile device 102 is moving in a direction 1403. The mobile device 102 transmits data to the server 104 indicating this direction 1403, its current location (e.g., step 1202 of FIG. 12) and/or any other suitable parameters e.g., speed, acceleration, etc.

Based on the above data, the server 104 then determines various locations that would be of particular interest to a user of the mobile device 102 based on the trajectory or expected path of the mobile device 102. In this example, the server 104 determines, based on the direction 1403 that the mobile device 102 is moving, that the mobile device 102 and its user are likely to come upon locations 1406 and 1408, which represent notable landmarks in the nearby area. This is because the server determines that locations 1406 and 1408 are in a path 1411 defined by the movement, trajectory and/or direction 1403 of the mobile device 102. However, the server 104 also determines that locations 1404 and 1410 will likely not be encountered by the mobile device user, because they are outside of the expected path 1411 and trajectory of the mobile device 102. Thus, the server 104 determines that only data indicating locations 1406 and 1408 will later be sent to the mobile device 102.

Another approach for determining prepropagation location data involves analyzing or predicting the preferences or future actions of the mobile device user. By way of example, if the server receives a geocoordinate from the mobile device 102, indicating that the device is at a particular location A, then the server 104 may be able to predict that the mobile device 102 will possibly move to a known location B. This prediction may be based on a wide variety of factors, including a user profile, a history of past user actions or movements, any data stored on the mobile device (e.g., calendar data, appointment data, notes, preferences, etc.), a history of actions or movements by other mobile device users, etc. Additionally, in various implementations, the user determines that the user will likely also arrive at location C, because C is along a known path or trajectory that the mobile device will likely traverse to get from location A to B. In this example, the server then would prepopagate the cache of the user's mobile device with location data for locations B and/or C.

Returning to FIG. 12, at step 1208, the server transmits the precomputed regions or selected locations to the mobile device 102. If the user designated conditions at step 1202 (e.g., only at night, when the mobile device is charging, etc.) under which prepoagation can occur, the prepoagation is performed only when those conditions are met. In the example shown in FIG. 13, the server transmits regions/squares marked A, B and C (i.e., the regions that are each wholly within only a single and not multiple administrative regions) to the mobile device 102. In the example shown in FIG. 14, the server transmits geocoordinates that indicate the geographical locations of landmarks 1406 and 1408 and/or the names of the geographical locations themselves. This transmitted data may take a variety of forms. In some embodiments, for example, the transmitted data is similar or identical to the data illustrated in FIG. 3. That is, the transmitted data includes one or more entries, each entry including at least a geocoordinate and associated one or more names of associated locations (e.g., addresses, names of organizations, cities, administrative regions, etc.) that the geocoordinate points to.

In various implementations, the server 104 does not transmit data that defines regions of a predefined size and that each cover a range of geocoordinates. Instead, the server 104 sends specific geocoordinates that each refer to a single point in a larger area (e.g., as is the case with a specific latitude-longitude coordinate pair). It is then expected that the mobile device will generate suitable proximity domains or regions (e.g., hulls, radius formed circles, etc.) as appropriate based at least in part on the specific geocoordinates to determine if there is a cache hit. In other embodiments, the server precomputes regions (e.g., the regions discussed in FIGS. 13A-13C) and transmits them to the mobile device 102. At step 1210, the mobile device 102 receives the location data (i.e., regions and/or specific points) from the server 104 and then stores it in the cache 106.

If the cache 106 at the mobile device 102 is prepropagated with regions or locations that are close to the current position of the mobile device 102, it is more likely that as the mobile devices moves from place to place, any reverse geocoding requests will be met by the cache and will not require a server call. This helps reduces bandwidth and power consumption, even when the mobile device is relatively new and has not filled up the cache through its own activity.

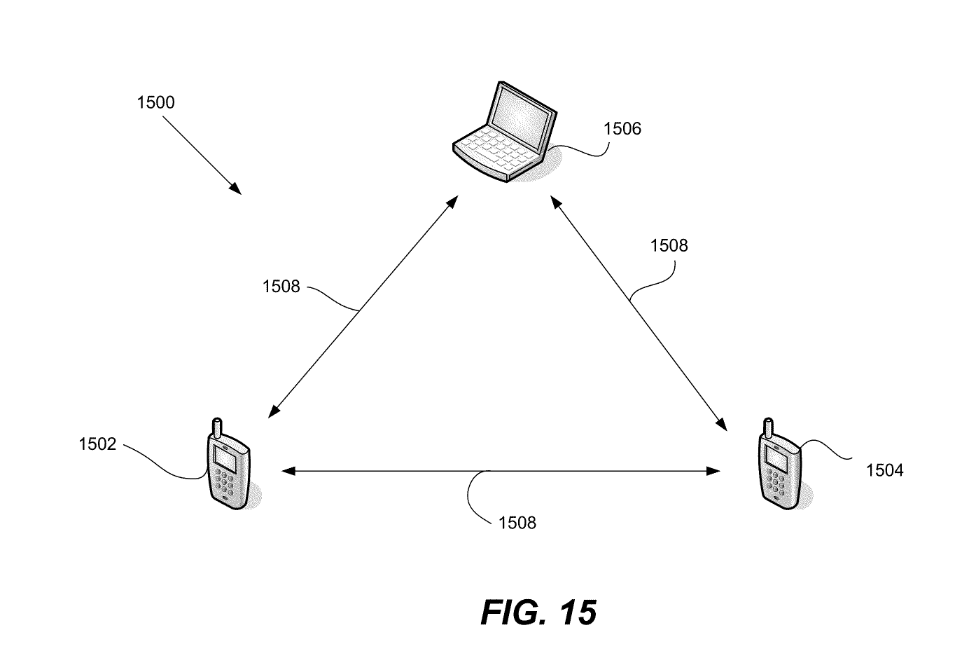

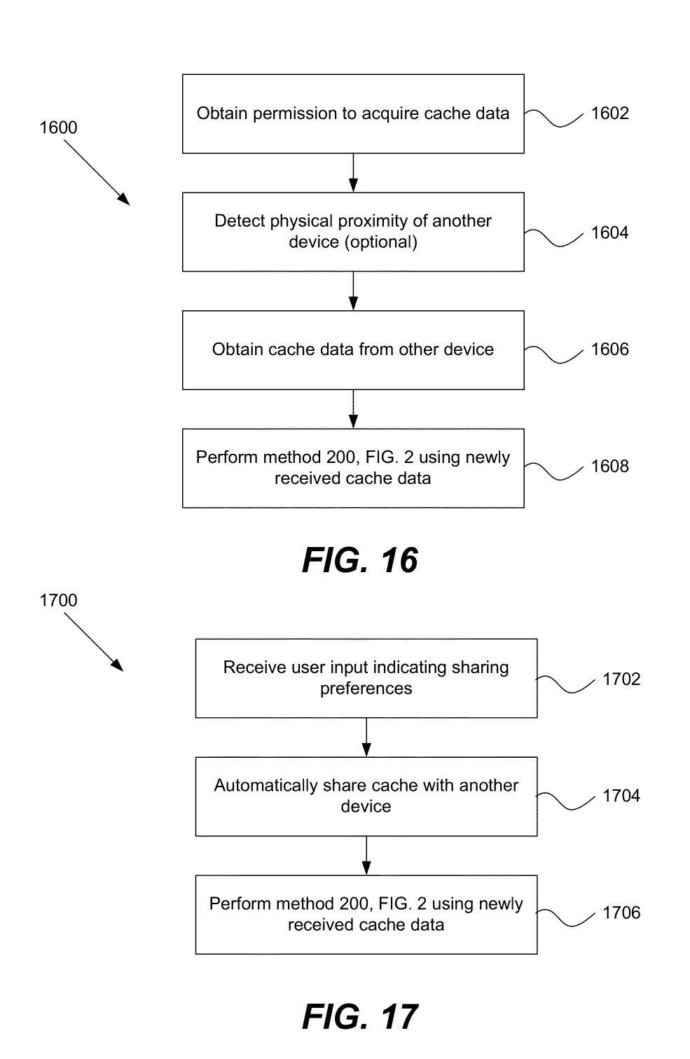

Referring next to FIG. 15, a diagram illustrating a system 1500 of multiple networked devices according to a particular embodiment of the present invention will be described. In the illustrated embodiment, each of the devices includes a location cache (e.g., similar or identical to cache 106 of FIG. 1), which it can share with the other devices. In some implementations, a device checks a cache in another device rather than checking its own cache. As a result, a device need not be limited to the contents of its own cache, but can access and use cached location data obtained from other devices.

The network devices include mobile devices 1502, 1504 and 1506. Each device may be any suitable computing device, including but not limited to a laptop, a smartphone, smart glasses, a smart watch, a computer, etc. In various embodiments, each of the devices has any or all of the features of mobile device 102 of FIG. 1.

The three devices are able to communicate with one another using any suitable network 1508. In this example, the networks are generally short-range networks that use any suitable communication protocol, including but not limited to Bluetooth, Bluetooth LE, WiFi and/or NFC. The network can be used to exchange or access cache data, as will be described in greater detail below.

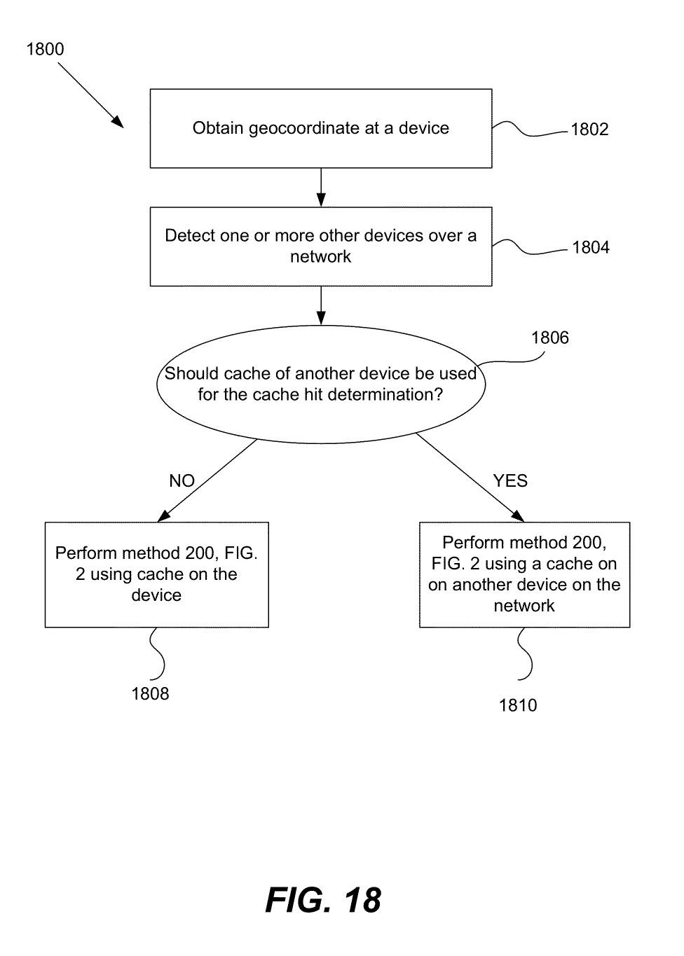

Referring next to FIG. 16, a method 1600 for exchanging or transferring cache data between devices over a short range network 1508 will be described. Initially, at step 1602, mobile device 1502 obtains permission to acquire cache data from mobile device 1504.

The procedure used to obtain permission may vary depending on the devices and the network 1508. In one particular implementation, the mobile device 1502 uses a short range network 1508, such as Bluetooth, Bluetooth LE or NFC, to communicate with the mobile device 1504. A user of the mobile device 1502 provides input to the device, which causes it to send a request for cache access to the mobile device 1504. The request is received by mobile device 1504. In various embodiments, in response to the request a notification is displayed on the screen of the mobile device 1504. A user of the mobile device 1504 is then able to provide input to the mobile device 1504, indicating that the request for access is approved. Alternatively, the user can provide input to the mobile device 1504 indicating that the request for access is not accepted, in which case data transfer between the mobile devices is prevented and/or the network connection between the two devices is severed.

In some implementations, for data to be transferred from one cache to another, the mobile device 1502 optionally must detect a physical proximity of the mobile device 1504 (step 1604). By way of example, in various implementations using NFC or any other suitable short range network protocol, the user of the mobile device 1502 places his or her device very close to or in physical contact with the mobile device 1504 (e.g., placing the back surfaces of two smartphones or mobile devices flush against each other.) Optionally, the user of the mobile device 1502 also provides input to the mobile device 1502, which causes the mobile device 1502 to request access to the cache of the mobile device 1504. The user of the mobile device 1504 then receives an alert (e.g., a notification displayed on a screen), indicating the request, and can confirm the request by providing input to the mobile device 1504. In various designs, cache data cannot be transferred between the two devices until physical contact is established between the two devices.

Once the necessary permissions have been obtained, mobile device 1502 receives location data from the cache of mobile device 1504 (step 1606). In various embodiments, the transferred data has generally the same form and arrangement as the cache contents described in FIG. 3. That is, the transferred data may include multiple entries, where each entry includes a geocoordinate and one or more associated geographical locations or names of locations. The mobile device 1502 receives the data through the network 1508 and stores the data in its own cache 106. In some embodiments, the data transfer is two way. That is, at or around the same time, cache data from mobile device 1502 is transferred to mobile device 1504. Alternatively, the data transfer may instead be one way and in the reverse direction (i.e., cache data may be transmitted from mobile device 1504 to mobile device 1502.)

At step 1608, the mobile device 1502 performs the steps of method 200 of FIG. 2 using the newly received cache data. That is, after retrieving cache data from mobile device 1504, the cache 106 of the mobile device 1502 now includes data relating to a wider array of locations. By way of example, if the user of mobile device 1502 had not spent any time in San Francisco but the user of mobile device 1504 had spent substantial time using a tourism application in San Francisco, the user of mobile device 1502 may now have access to San Francisco-based locations in his or her cache. That is, if the user of the mobile device 1502 visits San Francisco, his or her mobile device 1502 may make a reverse geocoding request for an obtained geocoordinate (e.g., step 202 of FIG. 2). The response for the request may now be received locally from the cache (step 206 of FIG. 2) using cache data that was transferred from mobile device 1504. If the cache data transfer had not occurred, such requests might have instead required a server call, which consumes additional bandwidth and battery power.

Referring next to FIG. 17, an example method for sharing cache data using sharing preferences will be described. The method may be performed at the system of FIG. 15. This example method involves presetting sharing preferences at mobile devices so that cache data can be automatically shared across the mobile devices.

Initially, at step 1702, the mobile device 1502 receives user input indicating sharing preferences. This input may be entered using the user interface displayed at the mobile device 1502, audio commands or any other form of input. The user input indicates that the user is willing to share the location cache on the mobile device with one or other selected mobile devices in the system.

The sharing preferences may be configured in a variety of ways. In some embodiments, for example, the users of mobile devices 1502, 1504 and 1506 provide input to their mobile device that designate selected devices or accounts with which sharing should be allowed. In some embodiments, the user also provides input indicating whether cache data can be transmitted from the device, to the device, or both. Additionally, the user may indicate types of communications networks (e.g., WiFi, Bluetooth, etc.) through which sharing should be allowed, and the conditions under which any sharing should took place (e.g., while charging, at night, at certain times of the day, when WiFi is enabled, etc.)

The mobile device 1502 then detects whether the above sharing conditions are met. The mobile device 1504 does the same. If all conditions are met and the sharing preferences of mobile device 1502 and 1504 match, then the mobile devices automatically share some or all of the contents of their location caches, based on their sharing preferences (step 1704). For example, mobile device 1502 may have been configured to accept from and send cache data to mobile device 1504, while mobile device 1504 is configured to send cache data to but not accept cache data from mobile device 1502. Both mobile devices were set to share only when charging and when the devices are connected in the same WiFi network. Thus, when these conditions are met, mobile device 1502 will automatically receive cache data from mobile device 1504, but will not send cache data to mobile device 1504, since mobile device 1504 prohibited the acceptance of outside cache data.

In some embodiments, cache data is automatically shared or transferred between mobile devices based on the interests of the mobile device users. By way of example, sharing between the caches of two mobile devices may be allowed if an analysis of the data stored on the mobile devices indicates that the users have common interests or might visit similar places. Consider an example in which the users of mobile devices 1502 and 1504 both have an interest in surfing and beaches. This interest may be reflected in the data stored on their mobile devices (e.g., user profile, user history, history of movement of the device, calendar, preference settings, events, current and past locations of the mobile device, etc.) In various implementations, an application or service running on both devices determines, based on the above factors, that sharing of cache data would be beneficial, since the users would likely visit and be interested in the same locations (e.g., beaches, surfing areas, surfing stores, etc.) and/or because their devices are located within a predetermined distance of one another. Accordingly, the mobile device 1502 receives cache data from the cache of mobile device 1504.

Once mobile device 1502 receives the new cache data from mobile device 1504, the mobile device 1502 then performs the method 200 of FIG. 2 (step 1706). That is, the mobile device 1502 has access to a wider array of locations in its cache due to the receiving of cache data from the mobile device 1504. For example, the need to make reverse geocoding server requests may be reduced with respect to such locations. This step is generally similar to or the same as step 1608 of FIG. 16.

Referring next to FIG. 18, a method 1800 for selecting and accessing caches over a network will be described. Method 1800 of FIG. 18 may be performed at the system 1500 illustrated in FIG. 15. For the purpose of this example, each device in system includes a separate location cache and may be any type of computing device, including but not limited to a computer, a mobile device, a smartwatch, smart glasses, a laptop, a tablet etc. Each device may have any of the features of mobile device 102 of FIG. 1.

Initially, at step 1802, the device 1502 obtains a geocoordinate. Step 1802 may be similar to or the same as step 202 of FIG. 2. At step 1804, the device 1502 detects one or more other devices (e.g., devices 1504 and 1506) over the network 1508. The devices may be connected using any suitable network or communications protocol, such as the Internet, WiFi, Bluetooth etc.

At step 1806, the device 1502 determines whether its own cache or the cache of another device should be checked. That is, to identify a location associated with the obtained geocoordinate, a device will make a cache hit determination (e.g., as described in connection with method 200 of FIG. 2). Under selected conditions, it may be desirable for the device 1502 to utilize the cache of another device, rather than its own cache, for the cache hit determination and/or for other cache-related operations (e.g., making a reverse geocoding request to a server, storing a reverse geocoding result, etc.)

The determination of whether to use the cache of another device may be based on a wide variety of factors. In some embodiments, for example, the determination is based on the battery power remaining in any of the devices 1502/1504/1506, the memory storage available on any of the devices, the amount of data that is expected to be stored at a cache, the amount of bandwidth available for receiving location data from a server and/or the processing speed or capability to perform the caching on any of the devices. Generally, if the available resources (e.g., battery power, storage, bandwidth, processing power etc.) are low at the mobile device 1502, but are greater at another device, it can sometimes be desirable for mobile device 1502 to perform its cache hit determination and/or reverse geocoding operations (e.g., method 200 of FIG. 2) using the cache of the other device.

If the device 1502 determines that the location- and cache-related operations should be performed at the device 1502 and not at another device, then the device 1502 performs method 200 of FIG. 2 using the obtained geocoordinate (step 1808). That is, the device 1502 uses its own resources, cache and storage to perform the cache hit determination and other cache-related operations.

If the device 1502 determines that another device should perform those operations, then the device 1502 sends data to the other device through the network 1508 indicating this determination. In some embodiments, mobile device 1502 also sends the obtained geocoordinate to the other device, although the obtaining of the geocoordinate could also be performed instead at the remote device. Consider an example in which device 1502 is a smartphone that has dwindling battery power and device 1506 is a laptop with greater bandwidth, processing power and battery power.

Based on these factors, device 1502 sends data and the obtained geocoordinate to the laptop indicating that the cache hit determination should be performed at the laptop. The laptop then performs a cache hit determination (e.g., steps 204 and 206 of FIG. 2) using its cache and the obtained geocoordinate (step 1810). In some embodiments and/or depending on the preferences of the device 1502, the laptop may also perform a reverse geocoding server call as appropriate (e.g., as described in steps 210 and 212 of FIG. 2). The laptop then obtains one or more locations associated with the obtained geocoordinate (e.g., as described in steps 206 and 212 of FIG. 2). Afterward, the mobile device 1502 receives the locations from the laptop and/or uses them in a suitable application (e.g., a tourism application, a life logging application, etc.)

In various embodiments, before the above operations are performed and external cache data is accessed, the device(s) involved in the operations must grant permission to allow such access. For example, a user of the laptop can provide input to the laptop indicating which devices or accounts (e.g., device 1502) can access and/or control its cache. These permissions are then transmitted to device 1502 over the network 1508. Once device 1502 has confirmed that such permission was given, it may then proceed to access the cache of the laptop. The permissions may be provided in any suitable manner, including using any approach discussed in connection with steps 1602 and 1702 of FIGS. 16 and 17, respectively.

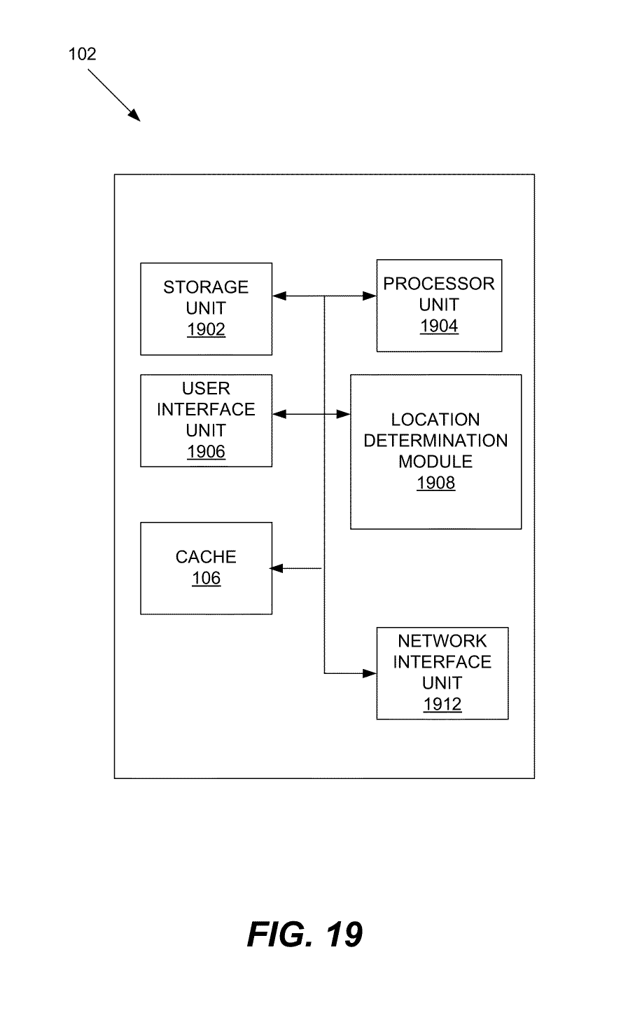

Referring next to FIG. 19, a mobile device 102 according to a particular embodiment of the present invention will be described. The mobile device 102 may be a wide variety of devices, including but not limited to a smartphone, a tablet, smart glasses, a smartwatch, a laptop or any other suitable computing device. The illustrated mobile device 102 may be the mobile device 102 of FIG. 1. The mobile device 102 includes a storage unit 1902, a processor unit 1904, a user interface unit 1906, a location determination module 1908, a cache 106 and a network interface unit 1912.

The storage unit 1902 is any mechanism or device suitable for storing data. For example, the storage unit 1902 may include volatile memory, non-volatile memory, flash memory, a hard drive and/or any suitable computer readable storage medium. In various embodiments, the storage unit 1902 stores computer software, an operating system and/or computer readable code that can be read and executed by the processor unit 1904.

The processor unit 1904 includes one or more processors. The processor unit 1904 is arranged to execute the computer executable code stored in the storage unit 702. The execution of the code can cause the mobile device 102 to perform any of the operations described in this application for a mobile device 102. For example, when executed, the code in the storage unit may cause the mobile device 102 to perform any of the steps described in method 200 of FIG. 2.

The network interface unit 1912 is one or more modules, antennae or other mechanisms that are arranged to connect the mobile device 102 to external networks. In various embodiments, the network interface unit 1912 is arranged to connect to any suitable wireless, wired and/or cellular network (e.g., Bluetooth, Bluetooth LE, Wi-Fi, GSM, NFC, CDMA, etc.) The mobile device 102 is arranged to transmit data, for example, to the server 104 of FIG. 2 through the network interface unit 1912. The mobile device 102 also receives location data from other devices or the server through the network interface unit 1912.

The user interface unit 1906 is any software and/or hardware used to help a user interact with the mobile device 102. Any suitable interface technologies may be used. In some embodiments, for example, the user interface unit 1906 includes a computer display screen, a touch sensitive (e.g., capacitive) screen, an e-ink display, a microphone that is arranged to receive audio commands, a keyboard, one or more switches or buttons, a microphone etc. In various embodiments, the user interface unit 1906 is arranged to display the graphical user interface described in connection with FIG. 10. The user interface unit is also arranged to display a user interface that allows a user to input user preferences and permissions for sharing cache data (e.g., as described in connection with FIGS. 16 and 17.)

The cache 106 is any software or hardware used to store location data, geocoordinate data and/or any data that helps the mobile device determine a location associated with a particular geocoordinate. In some embodiments, the cache stores data as illustrated in FIG. 3 e.g., using multiple entries, in which each entry associates a geocoordinate with one or more addresses or names of landmarks, organizations, entities, cities, states, provinces, districts, administrative regions or other locations. Any known cache algorithm may be used to access, remove and add to the data in the cache.

The location determination module 1908 is any software or hardware arranged to help determine a location that is associated with a particular geocoordinate. In various embodiments, for example, the location determination module 1908 obtains a geocoordinate (e.g., step 202 of FIG. 2) and accesses the cache to determine if there is a cache hit (step 204 of FIG. 2). The location determination module 1908 is also arranged to manage communications with the server 104 so that new location data can be received and stored in the cache 106 as appropriate. In various implementations, some or all of the functionality of the location determination module 1908 is implemented by one or more mobile applications or programs stored on the mobile device 102.

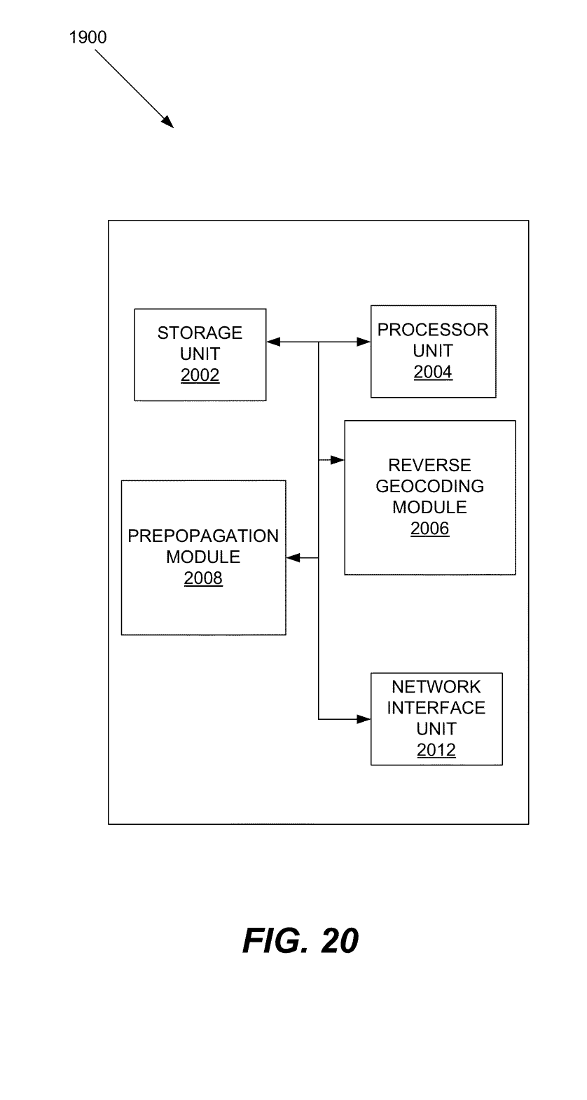

Referring next to FIG. 20, a server 104 according to a particular embodiment of the present invention will be described. The server 104 may be the server 104 of FIG. 1. The server 104 includes a network interface unit 2012, a processor unit 2004, a storage unit 2002, a prepopagation module 2008, and a reverse geocoding module 2006.

The storage unit 2002 is any mechanism or device suitable for storing data. For example, the storage unit 2002 may include volatile memory, non-volatile memory, flash memory, a hard drive and/or any suitable computer readable storage medium. In various embodiments, the storage unit 2002 stores computer software and/or computer readable code that can be read and executed by the processor unit.

The processor unit 2004 includes one or more processors. The processor unit 2004 is arranged to execute the computer executable code stored in the storage unit 2002. The execution of the code can cause the server 104 to perform any of the server operations described in this application. For example, when executed, the code in the storage unit may cause the server 104 to perform any of the server operations described in connection with method 200 of FIG. 2, or the method 1200 of FIG. 12.

The network interface unit 2012 is any hardware or software arranged to help connect the server 104 to a network. In various embodiments, the network interface unit 2012 helps connect the server 104 to any suitable wired or wireless networks (e.g., the Internet.) The server 104 is arranged to receive geocoordinates or reverse geocoding requests from a mobile device 102 through the network interface unit 2012. The server is also arranged to transmit data (e.g., location data for storage in a cache) to a device (e.g., mobile device 102 of FIG. 1) through the network interface unit 2012.

The reverse geocoding module 2006 is any software or hardware arranged to receive a geocoordinate from a mobile device 102 and determine one or more locations that the geocoordinate refers or points to. For example, if the location determination module receives the latitude-longitude coordinates 37.394403, −121.946181, the location determination module is arranged to consult a mapping tool, a database or any other suitable resource to determine that the coordinates point to and are associated with Peete's Coffee (a coffee shop) at 3932 Rivermark Plaza, Santa Clara, Calif. The reverse geocoding module 2006 is arranged to perform the server side operations of method 200 of FIG. 2 (e.g., receiving a geocoordinate from the mobile device 102, associating the geocoordinate with one or more locations, and/or sending the one or more locations to the mobile device.)

The prepropagation module 2008 is any software or hardware arranged to provide location data to the caches of mobile devices, even when the location data has not been specifically requested by the mobile devices. The prepopagation module 2008 is arranged to perform any of the methods and operations described in connection with FIGS. 12, 13A-13C and 14. For example, the prepopagation module 2008 is arranged to determine when and if cache data should be sent to a mobile device (e.g., step 1202 of FIG. 12). The precompting and/or selection of recommended locations to be sent to the mobile device may also be performed by the prepropagation module (e.g., steps 1204 and 1206 of FIG. 12).

It should be noted that any location cache (e.g., cache 106 of FIG. 1) described in this application may be application-specific or be accessible to multiple applications on a mobile device 102. That is, in some embodiments, the cache 106 is part of or dedicated to a particular computer program or mobile application. No other application can access or use the cache. Only the associated computer program can check the cache, perform a cache hit determination using the cache and/or store reverse geocoding results in the cache. However, in other embodiments, a shared cache 106 is accessed and used by multiple different applications. In various implementations, the shared cache 106 is built into the operating system of the mobile device 106. Multiple different applications can perform cache hit determinations using the shared cache 106 and can store reverse geocoding results in the shared cache 106.

This application sometimes refers to the transmitting of locations or location data from the server 104 to the mobile device 102. For example, this can occur when the server 104 is responding to a reverse geocoding request. It also can take place when the server 104 sends recommended locations to the mobile device 102 (e.g., as discussed in connection with FIG. 11) and/or when the server 104 prepropagates the cache of a mobile device 102 (e.g., method 1200 of FIG. 12). It should be appreciated that this location or location data can involve various different types of data. In some embodiments, for example, such locations or location data can include one or more of the following: a street address, a name of a city, a zip code, a name of a state, a name of any governmental or administrative region (e.g., a province, district, metropolitan area, county, etc.), a name of a landmark, a name of a business, a name of an organization, a name of a location and a name of an event. In still other embodiments, the location data has any of the features of the data described in FIG. 3, or any other known format or structure.

This application refers to various operations that are performed by the server and a (mobile) device. It should be appreciated that the server and the device may perform a wide variety of different types of operations in different implementations. In some implementations, for example, the server does not generate a proximity domain, a boundary region and/or any other type of cache hit determination mechanism, nor is this mechanism transmitted from the server to the device. Some embodiments involve a device that performs a cache hit determination using a proximity domain, boundary region or other cache hit determination mechanism that was generated locally and not at a remote server.

Although only a few embodiments of the invention have been described in detail, it should be appreciated that the invention may be implemented in many other forms without departing from the spirit or scope of the invention. For example, the figures include block diagrams. Each block diagram refers to a variety of different components. It should be appreciated that the features and functionality of one component may be transferred to another and the number of components and their arrangement may be different from what is shown in the figures. Any component can be divided into multiple components, or two or more components may be combined. Additionally, the figures for the application illustrate methods with various steps. These steps may be modified or reordered. In some embodiments, particular steps are removed or new steps are added as appropriate. Therefore, the present embodiments should be considered illustrative and not restrictive and the invention is not to be limited to the details given herein.

1. A method to determine a location of a device, comprising:
detecting a geocoordinate of the device using a sensor of the device;
if the geocoordinate matches an already visited geocoordinate stored on the device, obtaining the location of the device based on the already visited geocoordinate; and
performing a function using the location of the device.

2. The method of claim 1, further comprising:
if the geocoordinate does not match an already visited geocoordinate stored on the device, transmitting a request to a server for the location that is associated with the geocoordinate;
receiving a response from the server indicating the location; and
storing the location received from the server in a cache.

3. The method of claim 1, further comprising:
generating at the device one or more proximity domains, each proximity domain being associated with a different location; and
determining if the geocoordinate matches an already visited geocoordinate stored on the device by determining if the geocoordinate is within one of the proximity domains.

4. The method of claim 3 wherein:
the one or more proximity domains are generated at the device and not at another external device.

5. The method of claim 3 wherein:
the cache stores a plurality of geocoordinates that were previously obtained at the device; and
each proximity domain is based at least in part on at least one of the geocoordinates stored at the cache.

6. The method of claim 3 wherein the generation of the proximity domain involves at least one selected from the group consisting of a convex hull, a concave hull, a radius-formed circle, geocoordinates within a predetermined distance of a cached geocoordinate, geocoordinates within a predetermined distance of the obtained geocoordinate, implicit square hashing, R-tree partitioning, a spatial index and a predetermined region defined at least in part by a cached point.

7. The method of claim 1, the device being a first device, the method further comprising:
obtaining permission to acquire cache data from a cache of a second device that is connected to the first device using a short range network;
obtaining cache data from the second device;
storing the obtained cache data in the cache of the first device; and
performing the obtaining of the location using the obtained cache data.

8. The method of claim 1, the device being a first device, the method further comprising:
detecting a second device over a network, the second device having a cache for storing location data;
determining, at the first device, whether the first device should access the cache of the second device based on at least one selected from the group consisting of available bandwidth, available battery power, available processing power, amount of data that is expected to be stored in a cache and available memory storage; and
when it is determined that the first device should not access the cache of the second device, obtaining the location associated with the geocoordinate locally from the cache of the first device; and
when it is determined that the first device should access the cache of the second device, receiving the location from the cache of the second device and storing the location in the cache on the first device.

9. The method of claim 1, further comprising:
receiving status data from the device at a server;
determining at the server that the device should be prepropagated with location data;
transmitting location data from the server to the device;
storing the location data in the cache at the device; and
obtaining the location based at least in part on the location data received from the server.

10. The method of claim 9, further comprising:
determining that a device is moving in a particular direction;
based on the determined movement and direction, selecting one or more locations that are situated along an expected path of the device; and
transmiting the one or more locations to the device for storage in the cache.

11. The method of claim 9, further comprising:
precomputing one or more regions that each cover administrative regions within a predetermined distance of the device; and
transmitting the one or more regions to the device for storage in the cache.

12. The method of claim 1, further comprising:
determining that there is not a cache hit;
transmitting, from the device to a server, a request for a location associated with the geocoordinate;
determining, at the server, a first location associated with the geocoordinate;
recommending a second location based on at least one selected from the group consisting of a proximity of the first location to the second location, a user profile, user settings, past locations that the device was in, interests provided by the user and reverse geocoding requests from other devices;
transmitting data indicating the first and second locations from the server to the device; and
storing the first and second locations at the cache on the device.

13. The method of claim 1, further comprising:
recommending one or more other geocoordinates based on the current location and at least one selected from the group consisting of a user history, a user profile, user settings, past locations that the device was in and interests provided by the user;
determining whether each geocoordinate of a plurality of geocoordinates matches an already visited location stored on the device, the plurality of geocoordinates including the obtained geocoordinate and the one or more recommended geocoordinates;
when a particular one of the plurality of geocoordinates matches an already visited location stored on the device, performing the obtaining of the location from the cache; and
when a particular one of the plurality of geocoordinates does not match an already visited location stored on the device, transmitting a request to a server for a location and receiving a location from the server.

14. The method of claim 1, wherein performing a function using the location of the device comprises:
determining that a user is running an application selected from the group consisting of a tourism application and an application for guidance of the blind; and
generating an audio message that notifies a user of the location.

15. The method of claim 1, wherein performing a function using the location of the device comprises:
determining that a user is running a life logging application;
receiving input from the user indicating that a new log entry is desired; and
associating the log entry with the location.

16. The method of claim 1, wherein performing a function using the location of the device comprises:
determining that a user of the device is running a geofencing application on the device;
receiving input from the user, indicating that a reminder is desired when the user is at a particular target location; and
when the location matches the target location designated by the user, notifying the user of the reminder.

17. The method of claim 1, wherein performing a function using the location of the device comprises:
determining that a user of the device has launched a photo application at the device;
automatically obtain a geocoordinate for each photo wherein the geocoordinate helps identify where the photo was taken; and
organizing the photos into different groups based on the location received from the server or the cache.

18. The method of claim 1, further comprising:
receiving input from a user indicating that the obtained location is incorrect and should be corrected; and
correcting the location based on the user input and storing the corrected location in a cache.

19. The method of claim 1 wherein:
a cache includes a plurality of cache entries; and
each entry includes data indicating a geocoordinate that refers to a particular point in a geocoordinate system and one or more locations associated with the geocoordinate.

20. A computer readable storage medium that includes executable computer code embodied in a tangible form operable to determine a location of a device wherein the computer readable storage medium includes:
executable computer code operable to detect a geocoordinate of the device using a sensor of the device;
executable computer code operable to obtain the location of the device based on the already visited geocoordinate if the geocoordinate matches an already visited geocoordinate stored on the device; and
executable computer code operable to perform a function using the location of the device.

21. The computer readable storage medium of claim 20 wherein the computer readable storage medium further includes:
executable computer code operable to transmit a request to a server for the location that is associated with the geocoordinate if the geocoordinate does not match an already visited geocoordinate stored on the device;
executable computer code operable to receive a response from the server indicating the location; and
executable computer code operable to store the location received from the server in a cache.

22. A device, comprising:
at least one processor;
at least one memory including a computer readable storage medium that includes computer code stored in a tangible form wherein the computer code, when executed by the at least one processor, causes the device to:
detect a geocoordinate of the device using a sensor of the device;
if the geocoordinate matches an already visited geocoordinate stored on the device, obtain a location of the device based on the already visited geocoordinate; and
perform a function using the location of the device.

23. The device of claim 22, the computer readable storage medium further including computer code that, when executed by the at least one processor, causes the device to:
if the geocoordinate does not match an already visited geocoordinate stored on the device, transmit a request to a server for the location that is associated with the geocoordinate;
receive a response from the server indicating the location; and
store the location received from the server in a cache.

24. A device, comprising:
a sensor configured to detect a geocoordinate of the device;
a memory device configured to store a plurality of already visited geocoordinates; and
a processor, coupled to the sensor and the memory device, configured to obtain a location of the device based on matching the geocoordinate of the device with a particular one of the plurality of already visited geocoordinates.

25. The device of claim 24 wherein the processor is further configured to transmit a request to a server for the location that is associated with the geocoordinate if the geocoordinate does not match any of the plurality of already visited geocoordinates.
